(19) United States
(12) Patent Application Publication
(10) Pub. No.: US 2010/0022695 A1
(43) Pub. Date: Jan. 28, 2010

(54) FUSION BONDED NONIONIC SURFACE FINISH AND METHOD FOR MAKING SAME

(76) Inventor: Vinay G. Patel, Kansas City, KS (US)

Correspondence Address: CHRIS A. CASEIRO, VERRILL DANA, LLP, ONE PORTLAND SQUARE, PORTLAND, ME, 04112-0586, US

(21) Appl. No.: 12/509,200

(22) Filed: Jul. 24, 2009

Related U.S. Application Data
(60) Provisional application No. 61/083,572, filed on Jul. 25, 2008.

(51) Int. Cl. C09D 5/00

(52) U.S. Cl. 524/438; 525/50

(57) ABSTRACT

A fusion bonded nononic nano polymer surface finishing composition is described. Miniaturized molecules of polymeric particles deliver superior penetration and isolation of most soft and hard surfaces, insulating against oxidation, providing superior protection from soiling, staining and ultra violet degradation. The super smooth surface significantly reduces friction and mitigates static generation. Subsequent applications bond to previous applications and improve the surfaces protection.

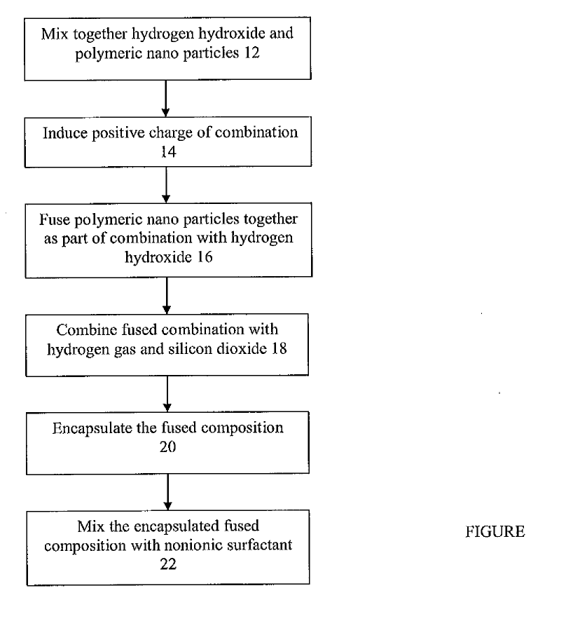

### CROSS REFERENCE TO RELATED APPLICATION

The present invention is related to, and claims the priority benefit of, U.S. provisional application No. 61/083,572, filed Jul. 25, 2008, entitled “E3—A FUSION BONDED NONIONIC NANO POLYMER SURFACE FINISHING SYSTEM” by the inventor of the present invention. The entire content of that application is incorporated herein by reference.

### BACKGROUND OF THE INVENTION

1. Field of the Invention

The present invention relates to compositions and methods for protecting surfaces. More paricularly, the present invention relates to polymer-based surface finishing systems. The present invention is a fusion bonded nonionic surface finish and method of making the same.

2. Description of the Prior Art

There is a continuing need for coatings, treatments or finishes that protect surfaces against adverse environments. For example, protective coatings are needed for a range of vehicles, including, but not limited to, automobiles. There is also a continuing need for treatments that improve the functionality of the surfaces of structures. For example, lubricants can be used to reduce friction between two surfaces. Preferably, surface treatments should be flexible and adherent under a range of conditions.

Typically, liquid coatings are used as protective coatings, but these suffer from a number of drawbacks, most notably the use of volatile organic compounds (VOCs) as solvents for their preparation and application. An increasing number of restrictions on VOCs has led to development of water-borne and high-solids coatings, the use of which has limitations due to long drying times, slow cure rates, and inadequate weatherability.

Films and coatings comprising fluoro-containing polymers are known and their inertness toward moisture, many solvents, and weathering conditions is known. For example, Teflon™ available from the DuPont Company is a poly(tetrafluoroethylene) compound that has found considerable use as a repellant for rain when incorporated into or spray-applied to clothing, upholstery, and other fabrics. However, fluoro-containing polymers are generally non-polar and do not easily adhere to many common surfaces such as wood, metals, and other polymers. In addition, fluoro-containing polymers generally are more expensive than their hydrocarbon polymer counterparts. Improved, cost-effective, strongly-adhering, long-lasting fluoro-containing polymer protective coatings are continually in demand.

Free-standing protective and/or decorative multi-layer films for outdoor use (e.g., outdoor signs, automobile bodies) are known. Typically, such films comprise an adhesive layer, a film layer that may optionally be pigmented, and an overlay or protective layer. Effective protective films must adhere strongly to the substrate (which is often a metal or an already-coated metal) and withstand challenges from heat, oxidants, solvents, sunlight, scratches, and impinged objects such as hailstones and rocks while maintaining their gloss or other decorative aspects, and, in many cases, be easily removable without leaving residual adhesive. However, such types of treatments are costly and require special attention to the application process.

Most automotive treatment products are use-specific in the sense that they can be used only on one type of surface. For example, although waxes are effective in protecting and restoring automobile paint finishes, they do not work well on most vinyl surfaces. This is because wax clogs the surface indentations creating the roughened surface appearance of the vinyl finish, which in turn detracts rather than enhances the surface appearance of the finish. Polishing agents in the wax only make the problem worse, since they are even more visible than the wax itself.

A common feature of practically all wax-containing auto finish-treating products is that they require significant rubbing and/or buffing to be effective. This is not only time-consuming but also requires significant physical effort. Accordingly, a need also exists for a new auto finish-treating product which can be applied very easily, by simply wiping or other application method, without the rubbing or buffing steps normally required with conventional wax-containing products.

In the same way, auto surface-treating products formulated for use on vinyl and other polymer-based parts are not effective on paint, glass, rubber or metal finishes, while products useful on paint finishes may not be effective on metal, rubber, vinyls or other plastic finishes. In addition, auto surface-treating products formulated for use on exterior polymer-based parts are not effective on surfaces found in the interior portion of an automobile, such as leather, colored plastic, chrome or glass surfaces. Likewise, products used to treat interior surfaces of automobiles, such as leather, are not effective on exterior automobile surfaces, such as paint or metal finishes.

Traditional waxes and polishes that are the most common compositions to treat surfaces are mostly solvent borne, organic based polishing particles, these solvents, when exposed to sun light, evaporate, then the polishing solids abrade off the surface by force of contact with wind or water. In particular, the traditional waxes and polishes are mostly solvent borne suspensions of relatively large organic based polishing particles. The solvents evaporate when exposed to sunlight. The polishing solid particles then evaporate and are abraded off the surface by force of contact with wind, water or contact with other surfaces; or degraded by heat and “cooked” away.

Therefore, what is needed is a finish that is effective as a surface protectant and/or as a surface enhancement, is relatively easy to apply and cost effective. The finish should not harm the surface to which it is applied. What is also needed is a method for making such a finish.

### SUMMARY OF THE INVENTION

It is an object of the present invention to provide a finish that is effective as a surface protectant and/or as a surface enhancement. It is also an object of the present invention to provide such a finish that is relatively easy to apply and is cost effective. The present invention is fabricated to avoid or minimize harm to the surface to which it is applied. Further, it is an object of the present invention to provide a method of making such a finish.

The present invention is a combination of polymeric nanoparticles and hydrogen hydroxide fused together to establish what is referred to herein as a polymeric nano fusion composition. In general, nano particles are those particles having at least one dimension that is less than 100 nanometers. For purposes of the present invention, polymeric nano particles are approximately about 100 nanometers or smaller, but not specifically limited thereto. Instead, the polymeric nano particles of the present invention are any polymeric particles sufficiently small enough to fit within interstices, holes, valleys, etc. of a body having a surface to be finished.

The composition of the present invention is formed by fusing together polymeric nano particles with hydrogen hydroxide and then encapsulating that fused combination in the manner to be described herein. In general, however, the process of fabrication includes the steps of chemically and electromagnetically fusing polymeric particles at the sub micron level. Each component of the composition, working in concert with the others, provides a surface finish that is more easily and more quickly applied across a broad spectrum of environmental conditions. It is environmentally friendly, hard, more solid and deeper penetrating than conventional finishes. It remains functional to 400° C. and provides significantly greater protection from sun, soil, staining, static and friction than traditional finishes.

The composition finish of the present invention can be used to mitigate static electricity through negative charging of the polymeric nano particles during the fabrication process and hydrogen fusion bonding of the particles. The nano particles are small enough to penetrate the surface and sub surface of the body to be treated to create a permanent bond by filling nano and micro pores on the top of and inside the surface.

The composition finish can be used as a dry lubricant, a mold release agent, ultraviolet protection for laminated composites, such as sail boat sails; to improve the “slip” of watercraft through the water and aircraft through the air. It can be used to finish automobile surfaces, other vehicles, boats, airplanes, LCD and plasma TV screens, LED screens, computer screens, and cell/mobile phone screens. It can be used on all precious metals, diamonds, natural and man made stone and all imitation jewelry. Further, it can be used on kitchen counter tops, refrigerators, ovens, microwaves and all household electronic appliances inside and out. It makes the surface of the body treated slick and smooth. It keeps soil and bacteria from penetrating the surface, making future cleaning much easier, faster and helps keep surface sanitary.

The composition finish is a fusion-bonded nonionic nano polymer surface finishing system. Fusion bonded UV protected polymeric particles flow into the surface forming an integral bond with the surface, minimizing the abrasive effect of wind, water or contact with other surfaces. When the water carrier evaporates, the polymer forms a superior, alloy like bond, isolating the surface, and requiring reapplication far less often.

The invention is a fusion-bonded nononic nano polymer surface finishing system. The nanometer-sized polymeric particles deliver superior penetration and isolation of most soft and hard surfaces, insulating against oxidation, providing superior protection from soiling, staining and ultra violet degradation. The super smooth surface significantly reduces friction and mitigates static generation. Subsequent applications bond to previous applications and improve the surfaces protection. The finish reduces friction, repels dust, dirt and moisture, and inhibits oxidation, corrosion, pollution, static, fading and UV damage. It is a water-based fusion structure including polymeric nano particles that delivers the best protection known to any surface, with no environmental harm. The finish may be used to protect most any structure to which it is applied with little to no adverse impact on the environment.

The finish may be used on hard or soft surfaces, It may be used on painted, plated anodized or unfinished metals, fiberglass, Plexiglas, composites, canvas, upholstery, finished or unfinished wood, stone, granite, marble and gemstones. It may be used on cars, consoles, dashboards, windshields, boats, sails, soft sides and windows, awnings, heavy equipment or computer screens, eyeglasses, countertops, bath fixtures, furniture, cabinets, fishing gear, firearms, concrete, tools, lawn mowers, snow equipment, and dump truck beds, but is not limited thereto.

These and other advantages of the present invention will become apparent upon review of the following detailed description, the accompanying drawing and the appended claims.

### BRIEF DESCRIPTION OF THE DRAWING

The FIGURE is a simplified representation of the primary process steps associated with making the composition finish of the present invention.

### DETAILED DESCRIPTION OF THE INVENTION

A water borne nonionic ultraviolet protected nano polymer particle fusion surface finish of the present invention is made by a process 10 represented in the FIGURE. First, in step 12, hydrogen hydroxide and nanometer size polymeric particles are mixed together using a conventional high shear, high speed mixer, such as Charles Ross and Son Batch High Shear mixer or similar. The polymeric particles added to the mixer are in powder form and may be fabricated of polymers known generally to those of skill in the art. It is to be noted that one or more polymer types may be used in the finish dependent upon the specific application. For example, a single polymeric particle may be employed when the finish is to be used as a surface protectant, such as a car surface finish. In another example, two or more different polymeric particle types may be employed when the finish is to be used to establish low surface friction and high ultraviolet resistance, such as a treatment for the wing of an aircraft. The hydrogen hydroxide and the polymeric particles are combined together in a weight ratio of about 1.5/1 hydrogen hydroxide to polymeric material, wherein the hydrogen hydroxide is about 60% by weight of the composition and the polymeric particle is about 40% by weight of the composition.

In step 14, that combination of hydrogen hydroxide and polymeric nano particles is passed through an electromagnetic device for about ten minutes at about 75° F. to about 85° F. to give the combination a positive charge to facilitate further fusion processes. The electromagnetic device may be any sort of induction tool configured to encourage positive charges to the surface of the mixture. It is operated near the mixture to attract positive charges to the surface. A grounding device is also used to remove negative charges from the mixture. In step 16, the combination of hydrogen hydroxide and polymeric particle is delivered to a temperature-controlled container, such as a closed stainless steel vat, where it is held for about for 30 minutes at about 95° F. where the polymeric particles are further reduced in size and the continued heating of the combination at this relatively low temperature ensures continued interaction of the hydrogen hydroxide and the polymeric particles for their fusing together. Additionally, the conditioning of the solution at this temperature enable the polymeric particles to later bond with a broad variety of surfaces, hard and soft, affording exceptional protections without negative impact on the surfaces.

With continuing reference to the FIGURE, in step 18, hydrogen gas is combined with silicon dioxide to facilitate the bonding of hydrogen molecules with the solution to later provide a chemical means of mitigating static generation and providing surface tension mitigation of the composition in subsequent steps described herein. The combination of hydrogen gas and silicon dioxide is passed through the fusion bonded composition in the same or another container, such as a closed stainless steel wet chamber, but not limited thereto, at about 68° F. to cool the composition for about ten minutes to condition the composition for subsequent fusion with, and dispersion among, water in the event the surface finish is to be diluted. The dilution ratio may be varied and is dependent upon the particular application of interest. There may be applications in which no dilution is needed. That fusion and/or dispersion with water is accomplished through subsequent mixing with water.

In step 20, the molecules of the composition are encapsulated to provide most of the molecules of the composition with very smooth surfaces, resulting in an overall composition of low frictional characteristics and reduced surface tension. The composition is encapsulated by introducing additional polymeric particles and hydrogen conditioned with silicone dioxide to the fused combination, thereby establishing an atomic deposition that is an ultra thin solid sealing coating on the fused polymeric particles. This atomic layer deposition takes place in a closed stainless steel chamber where the composition is introduced and any extra hydrogen molecules and silicon dioxide from one or more of the prior steps are exhausted from the chamber. Specifically, the encapsulated composition is retained in the chamber at about room temperature for about 20 minutes per 100 gallons of the composition in process to ensure sufficient removal of excess hydrogen and silicon dioxide. This ultra thin vapor-deposited solid coating enhances the mechanical, electrical, tribological and chemical characteristics of the product. It is to be noted that this polymeric nano particle encapsulation is identified as a distinct step herein, but effectively occurs in the course of the process step 18

In step 22 of the process 10, the completed fusion-bonded composition is merged in an open stainless steel chamber with a nonionic surfactant including a hydrophilic section and a hydrophobic section. Alcohol ethoxylates, such as linear ethoxylated alcohol, have been found to be suitable nonionic surfactants to be used in combination with the composition to promote bonding characteristics of the composition and to facilitate the evaporation of any excess components of the combination described above not required to enhance the effectiveness of the composition. The nonionic surfactant is a small portion of the finish. It is about 0.5% by weight of the composition of the finish. The composition and the surfactant are emulsified together by mixing them together vigorously in the chamber, preferably, but not required, at room temperature. A conventional high shear, high speed mixer known to those of skill in the art may be used for this purpose. This mixing ensures that the composition will remain suspended with the surfactant for an extended period of time. The indicated combination may be emulsified again in the event of any separation that may occur, by repeating the vigorous mixing step. Water may also be used to dilute the combination.

In one embodiment of the nonionic ultraviolet protected nano polymer particle fusion surface finish of the present invention fabricated using the steps of the process 10 described above was applied to a set of golf balls for the purpose of determining whether the finish would reduce the frictional characteristics of the surface of the treated balls. The composition in emulsion form was brushed onto all surfaces of the balls to be treated and allowed to dry by allowing the surfactant to evaporate. A total of 24 identical Titleist NXT Tour golf balls were used in the experiment. Twelve of the balls were untreated and 12 were treated with the surface finish. Each ball was placed on a tee and hit by a golfer qualified to have a handicap of two. The treated and untreated balls were hit alternatively. Their ball speeds, launch angles, spin rates, side spin values, carry distances and total distances were measured. It was determined that the treated balls, on average, gained 4% additional distance and had a spin reduction of 5% when compared to the averages of those characteristics for the untreated balls,

While the invention has been described with specific reference to particular components of the composition and the use of particular steps, it is to be understood that the invention includes all reasonable equivalents.

What is claimed is:

1. A composition for finishing a surface of a structure, the composition comprising a mixture of a plurality of polymeric nano particles and hydrogen hydroxide fused together.

2. The composition as claimed in claim 1 wherein the hydrogen hydroxide and the polymeric nano particles are combined together in a weight ratio of about 1.5/1 hydrogen hydroxide to polymeric nano particles.

3. The composition as claimed in claim 1 wherein the plurality of polymeric nano particles comprises one or more types of polymeric materials.

4. The composition as claimed in claim 1 wherein the polymeric nano particles are no more than 75 nanometers in any dimension.

5. The composition as claimed in claim 1 further comprising a nonionic surfactant.

6. The composition as claimed in claim 5 wherein the nonionic surfactant is a linear ethoxylated alcohol.

7. The composition as claimed in claim 5 wherein the nonionic surfactant comprises about 0.5% by weight of the composition.

8. A method for fabricating a composition for finishing a surface of a structure, the method comprising the steps of:
a. mixing together hydrogen hydroxide and nanometer size polymeric particles to form a mixture;
b. passing the mixture through an electromagnetic device for to give the mixture a positive charge;
c. delivering the mixture to a temperature-controlled container to reduce the size of the polymeric particles and to fuse them together;
d. passing hydrogen gas through the mixture to cool the mixture to condition it for fusion with, and dispersion among, water molecules; and
e. encapsulating molecules of the mixture composition.

9. The method as claimed in claim 8 wherein the step of passing the mixture through the electromagnetic device includes passing it through the device for about ten minutes at about 75° F. to about 85° F.

10. The method as claimed in claim 9 wherein the mixture is held in the temperature-controlled container for about for 30 minutes at about 95° F.

11. The method as claimed in claim 8 further comprising the step of merging the mixture with a nonionic surfactant.

12. The method as claimed in claim 11 wherein the nonionic surfactant is a linear ethoxylated alcohol.

13. The method as claimed in claim 12 wherein the linear ethoxylated alcohol comprises about 0.5% by weight of the mixture.

14. The method as claimed in claim 13 wherein the step of merging includes using a high shear, high speed mixer at room temperature to bond the mixture with the linear ethoxylated alcohol.
